(19) United States
(12) Patent Application Publication
(10) Pub. No.: US 2016/0203913 A1
(43) Pub. Date: Jul. 14, 2016

(54) MULTI-LAYERED CERAMIC ELECTRONIC DEVICE, METHOD FOR MAKING SAME

(71) Applicant: HOLY STONE ENTERPRISE CO., LTD, Taipei City (TW)

(72) Inventors: Szu-Lung SUN, Hsinchu City (TW); Hung-Mou HUANG, Taipei City (TW); I-Chun LING, Taoyuan County (TW)

(21) Appl. No.: 14/826,593

(22) Filed: Aug. 14, 2015

(30) Foreign Application Priority Data
Jan. 8, 2015 (TW) 104100525

(51) Int. Cl. H01G 4/236; H01G 4/12; H01G 4/005

(52) U.S. Cl. CPC H01G 4/236; H01G 4/005; H01G 4/12

(57) ABSTRACT

A multi-layered ceramic electronic device is made by attaching respective inner bonding surfaces of two lead frames to two opposite electrode junctions of a multi-layered ceramic chip in such a manner that a predetermined buffer space is defined between respective bottom bonding portions of the lead frames and the bottom side of the multi-layered ceramic chip, and then applying a conductive polymer adhesive to bond the inner bonding surfaces of the lead frames to the electrode junctions of the multi-layered ceramic chip at a predetermined low bonding temperature and to electrically conduct the leaf frames to the electrode junctions of the multi-layered ceramic chip.

This application claims the priority benefit of Taiwan patent application number 104100525, filed on Jan. 8, 2015

### BACKGROUND OF THE INVENTION

1. Field of the Invention

The present invention relates to multilayered ceramic technology and more particularly, to a multi-layered ceramic electronic device and a method for making the multi-layered ceramic electronic device by bonding respective inner bonding surfaces of two lead frames to two opposite electrode junctions of a multi-layered ceramic chip with a conductive polymer adhesive at a predetermined low bonding temperature to prevent cracking or breaking of the multi-layered ceramic chip.

2. Description of the Related Art

Electronic components can be classified as active components and passive components. Active components (such as IC or CPU) are electronic components that require a source of energy to perform their intended functions. Passive components are those that do not require electrical power to operate (e.g., not capable of power gain). The three main passive components used in any circuit are the: Resistor, the Capacitor, and the Inductor. All three of these passive components limit the flow of electrical current through a circuit but in very different ways. However, with regard to function, the capacitor stores charges in an electrostatic mode, and can discharge the electrical energy within a predetermined time, or work for filtering or side-wave coordination. It is now the market trend to make a passive component in the form of a chip. The development trend of integrated circuits toward high-performance and high-density and the creation of the surface mount technology (SMT) of high-speed assembly function have prompted the change of the mounting of many electronic components from the conventional pin through hole mounting technology to the chip-on-board surface mount technology (SMT). Therefore, the demand for on-chip passive components increases rapidly, and, it requires more and more small size. A capacitor is a passive two-terminal electrical component containing at least two electrical conductors (plates) separated by a dielectric (i.e. insulator). Capacitors have the ability to store energy in the form of an electrical charge producing a potential difference (static voltage) across their plates, much like a small rechargeable battery, and can also be used to differentiate between high-frequency and low-frequency signals. Capacitors can also be designed to provide shunting, filtering, coordinating or oscillating function. Further, single layer ceramic capacitors and multi-layered ceramic capacitors (MLCC) are commercially available. Multi-layered ceramic capacitors have the characteristics of high dielectric coefficient, good insulating capability, good heat resistance, small size, mass production applicability, high stability and reliability, high voltage and high heat resistance, wide operation temperature range, and SMT applicability. Further, the production speed of multi-layered ceramic capacitors (MLCC) is much higher than that of electrolytic capacitors and tantalum capacitors. The above-mentioned advantages lead the multi-layered ceramic capacitor into the mainstream of the capacitor industry. Therefore, multi-layered ceramic capacitors have been widely used in small-sized multi-functional electronic products.

When mounting a multi-layered ceramic capacitor on a circuit board using a surface mounting technology, the multi-layered ceramic capacitor is bonded to the surface of the circuit board in a flat manner. If the circuit board is curved during a processing process or application, the multi-layered ceramic capacitor can be forced to crack or to break. Further, when bonding a multi-layered ceramic capacitor to a circuit board, the bonding heat can cause the multi-layered ceramic capacitor to crack or to break.

Conductive spacer components can be soldered to the two opposite electrodes of the multi-layered ceramic capacitor. After the multi-layered ceramic capacitor is bonded to the circuit board by using the surface mounting technology, the conductive spacer components lift the multi-layered ceramic capacitor from the surface of the circuit board with a gap left between the surface of the circuit board and the bottom side of the multi-layered ceramic capacitor, preventing cracks in the multi-layered ceramic capacitor when the circuit board is curved during a processing process or application. However, because the conductive spacer components are soldered to the two opposite electrodes of the multi-layered ceramic capacitor at a temperature higher than 300° C., the multi-layered ceramic capacitor may be unstable to withstand this thermal impact. If the temperature rises rapidly during the bonding operation to bond the conductive spacer components to the two opposite electrodes of the multi-layered ceramic capacitor, the multi-layered ceramic capacitor will be unstable to withstand the rapid rise in temperature, causing cracks. Consequently, the yield of the fabrication yield will be lowered. If the rise in temperature during the bonding operation is too slow, the flux will flow in all directions to pollute related tools. Further, high temperature bonding is also easy to cause pollute the natural environment and the air. Further, when bonding the conductive spacer components to the two opposite electrodes of the multi-layered ceramic capacitor with a solder and flux, the molten solder and flux could be splashed into the air to contaminate the multi-layered ceramic capacitor and the surroundings. Thus, a cleaning work must be employed after the bonding operation. This cleaning work requires much labor and time. During the cleaning work, the applied cleaning solution can cause water pollution. Further, the applied solder and flux commonly contain 84%˜94% metals (such as lead, copper, tin, silver, etc.), halogen compounds [such as: chlorine (Cl₂), bromine (Br₂), iodine (I₂) or astatine (At)]≧900 (ppm), and heavy metals [such as lead (Pb), mercury (Hg), etc.] that can cause pollution to the natural environment.

US20140002952A1 discloses a stacked MLCC capacitor, entitled “Leadless Multi-layered Ceramic Capacitor Stacks”. The capacitor stack comprises multilayered ceramic capacitors wherein each multilayered ceramic capacitor comprises first electrodes and second electrodes in an alternating stack with a dielectric between each first electrode and each adjacent second electrode. The first electrodes terminate at a first side and the second electrodes second side. A first transient liquid phase sintering conductive layer is the first side and in electrical contact with each first electrode; and a second transient liquid phase sintering conductive layer is on the second side and in electrical contact with each second electrode. However, during the sintering operation, low melting point metal molecules will diffuse into the metal lead frame to bond to the ceramic layer. Further, when bonding the capacitor stack to a circuit board to heat the solder and filler composition, the low melting point metal will melt, lowering the bonding force between the layers, causing the solder and filler composition to shed, and weakening the strength of the bonding structure of the capacitor stack.

Therefore, it is desirable to provide a measure that eliminates the problem of cracks in the multi-layered ceramic capacitor caused by high bonding temperature and the pollution problem caused by the implementation of a cleaning work after the bonding operation.

### SUMMARY OF THE INVENTION

The present invention has been accomplished under the circumstances in view. It is one object of the present invention to provide a multi-layered ceramic electronic device and a method for making same, wherein the multi-layered ceramic electronic device is made by bonding two lead frames to respective electrode junctions of a multi-layered ceramic chip with a conductive polymer adhesive at a low bonding temperature, preventing cracking or breaking damage due to a high temperature, ensuring a high level of manufacturing safety and high yield.

To achieve this and other objects of the present invention, a multi-layered ceramic electronic device is made by attaching respective inner bonding surfaces of two lead frames to two opposite electrode junctions of a multi-layered ceramic chip in such a manner that a predetermined buffer space is defined between respective bottom bonding portions of the lead frames and the bottom side of the multi-layered ceramic chip, and then applying a conductive polymer adhesive to bond the inner bonding surfaces of the lead frames to the electrode junctions of the multi-layered ceramic chip at a predetermined low bonding temperature and to electrically conduct the leaf frames to the electrode junctions of the multi-layered ceramic chip. The inner bonding surfaces of the lead frames are preferably bonded to the electrode junctions of the multi-layered ceramic chip with the conductive polymer adhesive at a low bonding temperature of ≦200° C., or most preferably ≦150° C. Because the multi-layered ceramic chip and the lead frames are bonded together at a low bonding temperature, no further post-processing cleaning step is necessary, avoiding the use of cleaning solvents and preventing cracking or breaking of the multi-layered ceramic chip. Thus, the method of the present invention ensures a high level of manufacturing safety and high yield.

To achieve this and other objects of the present invention, a multi-layered ceramic electronic device comprises a multi-layered ceramic chip, two lead frames, and a conductive polymer adhesive. The multi-layered ceramic chip comprises two electrode junctions located at two opposite sides thereof. The two lead frames are respectively attached to the electrode junctions of the multi-layered ceramic chip, each comprising a flat inner bonding surface bonded to one respective electrode junction of the multi-layered ceramic chip and a bottom bonding portion spaced below a bottom side of the multi-layered ceramic chip. Thus, a buffer space is defined between the bottom bonding portions of the lead frames and the bottom side of the multi-layered ceramic chip. The conductive polymer adhesive is bonded between the two electrode junctions of the multi-layered ceramic chip and the inner bonding surfaces of the two lead frames to electrically conduct the lead frames to the multi-layered ceramic chip. Further, the flat inner bonding surfaces of the lead frames are respectively bonded to the electrode junctions of the multi-layered ceramic chip conductive polymer adhesive by the conductive polymer adhesive at a low bonding temperature of ≧200° C. or preferably ≧150° C. , reducing energy consumption and air pollution. Further, the conductive polymer adhesive can be a polymer resin containing no heavy metal [such as: cadmium (Cd), lead (Pb), mercury (Hg) or chromium (Cr)] and simply containing a small amount of halogen compounds [such as: chlorine (Cl₂), bromine (Br2), iodine (I₂) or astatine (At)]. Thus, no further post-processing cleaning step is necessary after bonding of the multi-layered ceramic chip with the lead frames, avoiding the use of cleaning solvents and effectively reducing environmental pollution. Further, the multi-layered ceramic electronic device can be a multi-layered ceramic capacitor.

Further, the conductive polymer adhesive has a high melting point, and can reliably withstand up to 300° C., passes the test method for solderability, resistance to dissolution of metallization and to soldering heat of surface mounting devices (SMD) of EN-60068-2-58 at 260° C.±5° C. Further, the conductive polymer adhesive has the characteristic of high extensibility and provides high bending ability, and thus, the electrode junctions of the multi-layered ceramic chip and the lead frames will not be easily forced apart to cause cracking or breaking damage to the multi-layered ceramic chip.

Further, the conductive polymer adhesive does not contain any low melting point metals. After the multi-layered ceramic electronic device is sintered, the conductive polymer adhesive is hardened. If the applied melting temperature that is applied to the conductive polymer adhesive surpasses the hardening temperature (150° C.), the conductive polymer adhesive in the multi-layered ceramic electronic device will not break. When bonding the multi-layered ceramic electronic device to the circuit board at a bonding temperature about 300° C., the adhesive bonding force of the conductive polymer adhesive remains unchanged, preventing separation between the multi-layered ceramic chip and the lead frames.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a flow chart of a multi-layered ceramic electronic device fabrication method in accordance with the present invention.

FIG. 2 is a side plain view of a multi-layered ceramic electronic device in accordance with the present invention.

FIG. 3 is an exploded side plain view of the multi-layered ceramic electronic device in accordance with the present invention.

FIG. 4 is an applied view illustrating the multi-layered ceramic electronic device bonded to a circuit board in accordance with the present invention.

FIG. 5 is chart illustrating the results of test made on multi-layered ceramic electronic devices with a conductive polymer adhesive in accordance with the present invention and multi-layered ceramic electronic devices using a conventional bonding technique.

### DETAILED DESCRIPTION OF THE PREFERRED EMBODIMENT

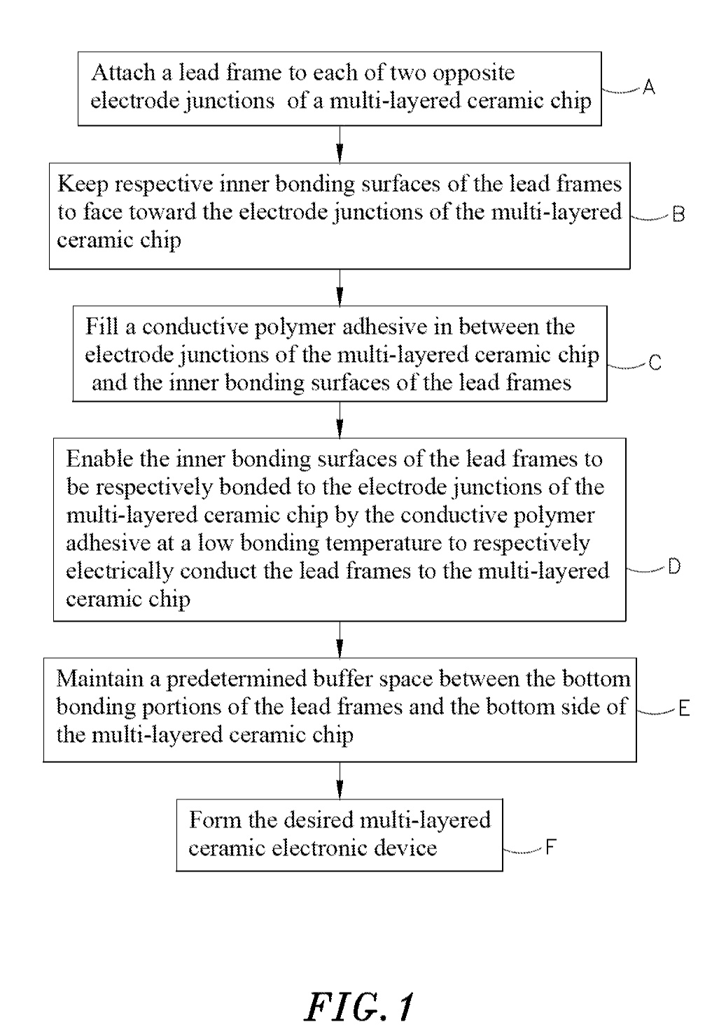

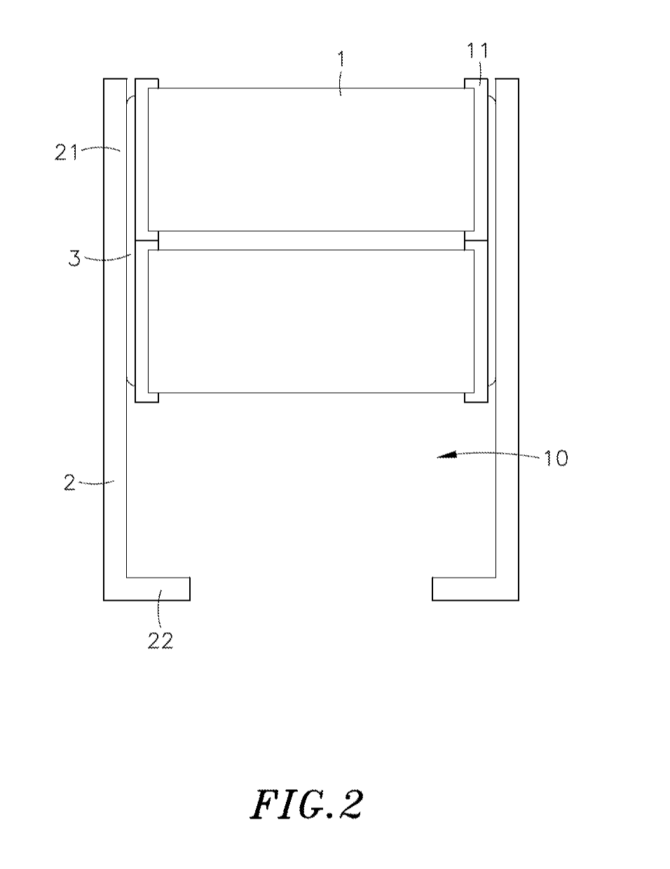

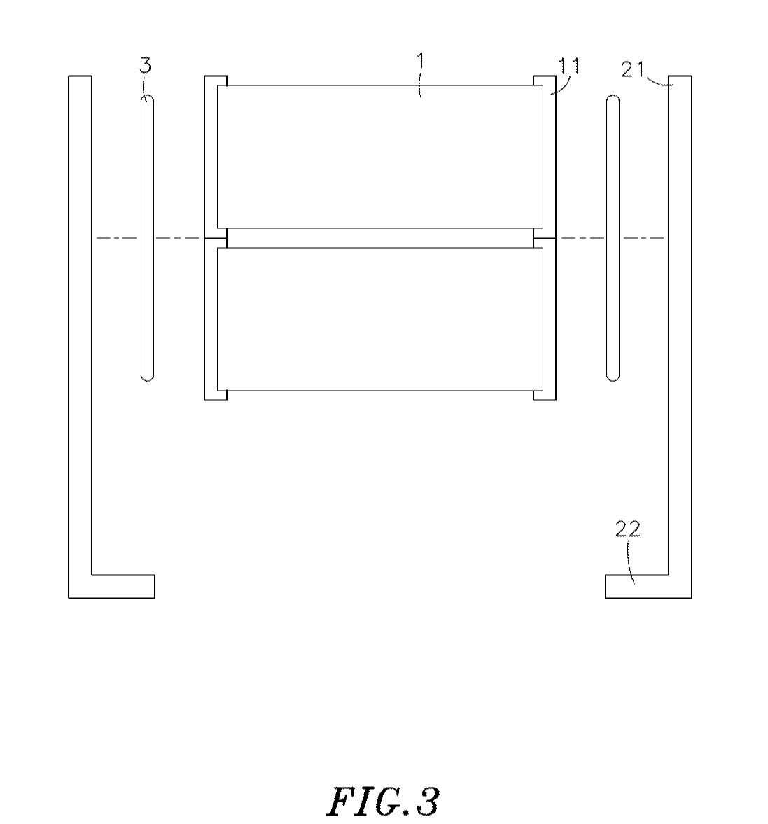

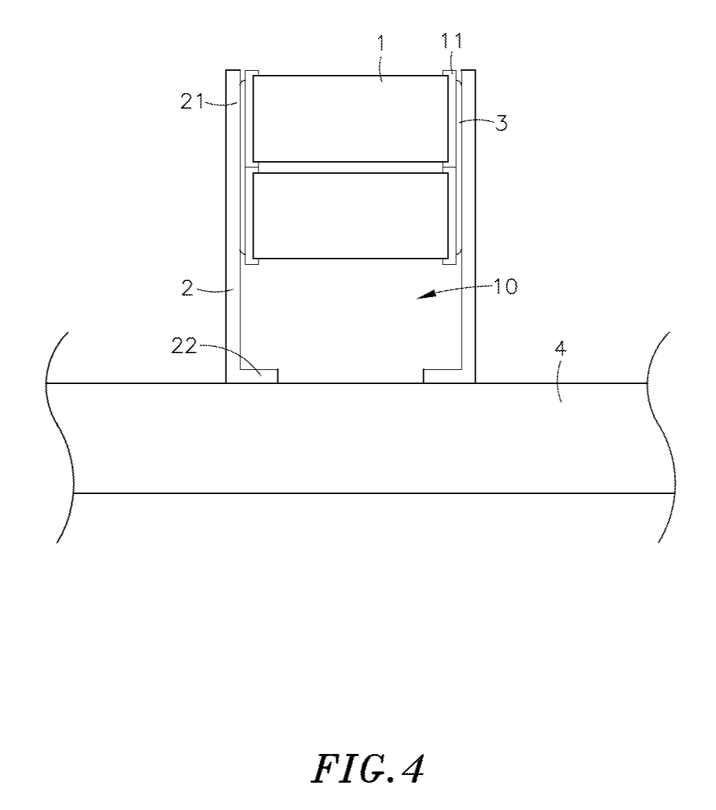

Referring to FIGS. 1-4, a method for making multi-layered ceramic electronic device in accordance with the present invention comprises the steps of:

(A) Attach a lead frame 2 to each of two opposite electrode junctions 11 of a multi-layered ceramic chip 1.

(B) Keep respective inner bonding surfaces 21 of the two lead frames 2 to face toward the electrode junctions 11 of the multi-layered ceramic chip 1.

(C) Fill a conductive polymer adhesive 3 in between the electrode junctions 11 of the multi-layered ceramic chip 1 and the inner bonding surfaces 21 of the two lead frames 2.

(D) Enable the inner bonding surfaces 21 of the two lead frames 2 to be respectively bonded to the electrode junctions 11 of the multi-layered ceramic chip 1 by the conductive polymer adhesive 3 at a low bonding temperature to respectively electrically conduct the lead frames 2 to the multi-layered ceramic chip 1.

(E) Maintain a predetermined buffer space 10 between respective bottom bonding portions 22 of the two lead frames 2 and a bottom side of the multi-layered ceramic chip 1.

(F) Form the desired multi-layered ceramic electronic device.

In the above-described manufacturing process, the inner bonding surfaces 21 of the two lead frames 2 are respectively bonded to the electrode junctions 11 of the multi-layered ceramic chip 1 by the conductive polymer adhesive 3 at a low bonding temperature (preferably ≦200° C., or most preferably ≦150° C.). Bonding the lead frames 2 to the multi-layered ceramic chip 1 by the conductive polymer adhesive 3 at this low bonding temperature level prevents cracking or breaking of the multi-layered ceramic chip 1. After the bonding process, the two lead frames 2 are respectively electrically conducted to the electrode junctions 11. Thus, the multi-layered ceramic chip 1, the lead frames 2 and a proper amount of the conductive polymer adhesive 3 are bonded together to make the desired multi-layered ceramic electronic device. This multi-layered ceramic electronic device can be, for example, a multi-layered ceramic capacitor.

The invention also provides a multi-layered ceramic electronic device comprised of a multi-layered ceramic chip 1, two lead frames 2 and a conductive polymer adhesive 3, wherein the multi-layered ceramic chip 1 is formed of stack of ceramic components, comprising two electrode junctions 11 at two opposite sides thereof; the lead frames 2 are made of a flat, L-shaped conductive metal material, each comprising a flat inner bonding surface 21 and a bottom bonding portion 22 perpendicularly extended from a bottom end of the flat inner bonding surface 21; the conductive polymer adhesive 3 has a low metal content and a high melting point, contains no heavy metals or halogen compounds, and can reliably withstand up to 300° C.

During the fabrication, attach the two lead frames 2 to the two opposite electrode junctions 11 of the multi-layered ceramic chip 1 to face the inner bonding surfaces 21 of the lead frames 2 toward the respective electrode junctions 11 of the multi-layered ceramic chip 1, and then bond the inner bonding surfaces 21 of the lead frames 2 to the respective electrode junctions 11 of the multi-layered ceramic chip 1 with the conductive polymer adhesive 3 at a predetermined low bonding temperature (preferably ≦200° C., or most preferably ≦150° C.).

Because the lead frames 2 are bonded to the multi-layered ceramic chip 1 with the conductive polymer adhesive 3 at a temperature ≦200° C. or ≦150° C., the multi-layered ceramic chip 1 will not crack or break during the bonding process. After the bonding process, the two lead frames 2 are respectively electrically conducted to the electrode junctions 11, and thus, the desired multi-layered ceramic electronic device is made. This multi-layered ceramic electronic device can be, for example, a multi-layered ceramic capacitor. Further, the conductive polymer adhesive 3 contain, for example, 75%˜85% of metal that can be selected from the group of silver (Ag), copper (Cu) and Nickel (Ni) metal and 15%˜25% of adhesive that can be a polymer resin containing no heavy metal [such as: cadmium (Cd), lead (Pb), mercury (Hg) or chromium (Cr)] and simply containing a small amount of halogen compounds [such as: chlorine (Cl₂), bromine (Br₂), iodine (I2) or astatine (At)]. The content of halogen compounds of the adhesive is ≦900 ppm. Thus, no further post-processing cleaning step is necessary, avoiding the use of cleaning solvents and effectively reducing environmental pollution. Further, the conductive polymer adhesive 3 has the characteristic of high extensibility and provides high bending ability, and thus, the electrode junctions 11 of the multi-layered ceramic chip 1 and the lead frames 2 will not be easily forced apart to cause cracking or breaking damage to the multi-layered ceramic chip 1. Further, the conductive polymer adhesive 3 has a high melting point and can reliably withstand up to 300° C. Further, the conductive polymer adhesive 3 passes the test method for solderability, resistance to dissolution of metallization and to soldering heat of surface mounting devices (SMD) of EN-60068-2-58 at 260° C.±5° C. The multi-layered ceramic chip 1 and the two lead frames 2 are bonded together under at a low bonding temperature under an open mode processing process, avoiding dangerous high temperature soldering and splashing of solder and flux, and reducing the degree of risk of the working environment. Therefore, the multi-layered ceramic electronic device manufacturing process of the present invention is relatively safer, and can greatly improve the yield.

Further, when mounting the multi-layered ceramic electronic device in a circuit board 4, bond the bottom bonding portions 22 of the lead frames 2 to the surface of the circuit board 4 using surface mounting technology (SMT), leaving the buffer space 10 between the multi-layered ceramic chip 1 and the circuit board 4. The buffer space 10 can be, for example, in the range about 0.8 mm˜2.5 mm. When bonding the bottom bonding portions 22 of the lead frames 2 to the surface of the circuit board 4, this buffer space 10 facilitates circulation of air and prevents direct transfer of heat to the multi-layered ceramic chip 1, and therefore, the multi-layered ceramic chip 1 will not break or crack as a result of excessive thermal stress. Further, if the circuit board 4 is forced to curve or deform by an external force during application, the buffer space 10 can buffer the pressure, preventing the multi-layered ceramic chip 1 from cracking or breaking, and therefore, the multi-layered ceramic chip 1 can be well protected and, the lifespan of the multi-layered ceramic chip 1 can be greatly prolonged. Further, the conductive polymer adhesive 3 does not contain any low melting point metal materials. After the multi-layered ceramic electronic device is sintered, the conductive polymer adhesive 3 (that can be a thermosetting resin) is hardened. If the applied melting temperature that is applied to the conductive polymer adhesive 3 surpasses the hardening temperature (150° C.), the conductive polymer adhesive 3 in the multi-layered ceramic electronic device will not break. When bonding the multi-layered ceramic electronic device to the circuit board 4 at a bonding temperature about 300° C., the adhesive bonding force of the conductive polymer adhesive 3 remains unchanged, preventing separation between the multi-layered ceramic chip 1 and the lead frames 2.

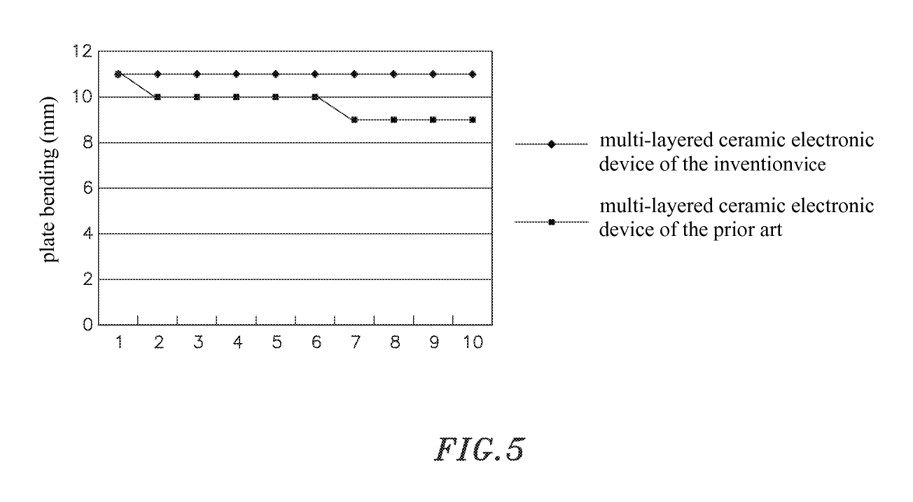

Further, the electrode junctions 11 of the multi-layered ceramic chip 1 and the inner bonding surfaces 21 of the lead frames 2 are bonded together by the conductive polymer adhesive 3 at a low bonding temperature. The conductive polymer adhesive 3 can be regarded as “soft terminal” between the lead frames 2 and the multi-layered ceramic chip (MLCC) 1. Because the conductive polymer adhesive 3 has good plastic deformation capacity, it still maintains appropriate elasticity and extensibility after solidification, and therefore, the conductive polymer adhesive 3 can work as a soft terminal with good plastic deformation capacity. When the product is forced by an external pressure, the conductive polymer adhesive 3 has high bending capacity. After the bottom bonding portions 22 of the lead frames 2 of the multi-layered ceramic electronic device are bonded to a circuit board 4, the product is examined through test. As FIG. 5 shows that the results of test made on multi-layered ceramic electronic devices with a conductive polymer adhesive in accordance with the present invention and multi-layered ceramic electronic devices using a conventional bonding technique.

In FIG. 5, the diamond line indicates the bending resistance of ten multi-layered ceramic electronic devices of the present invention; the square line indicates the bending resistance of ten multi-layered ceramic electronic devices of the prior art that employs a conventional high temperature bonding technique (the numbers 1-10 indicated at the bottom side of FIG. 5 represent 10 multi-layered ceramic electronic devices). The circuit board is treated through a plate bending test. As illustrated, the bending strength of the ten multi-layered ceramic electronic devices of the present invention is maintained at 11 mm, however, the bending strength of the ten multi-layered ceramic electronic devices of the prior art is lowered to 10 mm or 9 mm. If the circuit board 4 is bent by an external force, the multi-layered ceramic electronic devices of the prior art can crack or break while the multi-layered ceramic electronic devices of the present invention remains intact. Thus, the multi-layered ceramic electronic devices of the present invention will not be damaged during a subsequent processing of the circuit board.

Thus, even if the product suffers greatly external stress that the product cannot withstand, the product will break in the bonding area between the conductive polymer adhesive 3 and the multi-layered ceramic chip 1 to form an open mode without directly causing cracks in the multi-layered ceramic chip 1. Therefore, the use of the conductive polymer adhesive 3 to bond the lead frames 2 to the multi-layered ceramic chip 1 at a low bonding temperature can effectively protect the multi-layered ceramic capacitor from external stress damage, preventing plate burning risk when electrically conducted.

Further, because the conductive polymer adhesive 3 has high plastic deformability, it can offset the pulling stress between the lead frames 2 and the multi-layered ceramic chip (MLCC) 1 during the operation of the multi-layered ceramic capacitor to emit heat, preventing the multi-layered ceramic capacitor from pulling stress damage and prolonging the product lifespan.

In conclusion, the invention provides a multi-layered ceramic electronic device and a method for making same, wherein the multi-layered ceramic electronic device is made by: attaching a lead frame 2 to each of two opposite electrode junctions 11 of a multi-layered ceramic chip 1, and then keeping respective inner bonding surfaces 21 of the two lead frames 2 to face toward the electrode junctions 11 of the multi-layered ceramic chip 1, and then filling a conductive polymer adhesive 3 in between the electrode junctions 11 of the multi-layered ceramic chip 1 and the inner bonding surfaces 21 of the lead frames 2, and then enabling the inner bonding surfaces 21 of the lead frames 2 to be respectively bonded to the electrode junctions 11 of the multi-layered ceramic chip 1 by the conductive polymer adhesive 3 at a predetermined low bonding temperature to respectively electrically conduct the lead frames 2 to the multi-layered ceramic chip 1, and maintaining a predetermined buffer space 10 between a respective bottom bonding portion 22 of each lead frame 2 and a bottom side of the multi-layered ceramic chip 1, and then forming the desired multi-layered ceramic electronic device. Further, the conductive polymer adhesive can be a polymer resin containing no heavy metal and simply containing a small amount of halogen compounds. Thus, no further post-processing cleaning step is necessary after bonding of the multi-layered ceramic chip with the lead frames, avoiding the use of cleaning solvents and effectively reducing environmental pollution. Further, when the lead frames 2 of the multi-layered ceramic electronic device are bonded to a circuit board 4, the buffer space 10 is maintained between the surface of the circuit board 4 and the bottom side of the multi-layered ceramic chip 1. This buffer space 10 facilitates circulation of air and prevents direct transfer of heat to the multi-layered ceramic chip 1, and therefore, the multi-layered ceramic chip 1 will not break or crack as a result of excessive thermal stress. Further, if the circuit board 4 is forced to curve or deform by an external force during application, the buffer space 10 can buffer the pressure, preventing the multi-layered ceramic chip 1 from cracking or breaking, and therefore, the multi-layered ceramic chip 1 can be well protected and, the lifespan of the multi-layered ceramic chip 1 can be greatly prolonged.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A method for making a multi-layered ceramic electronic device, comprising the steps of:
(A) attaching a lead frame to each of two opposite electrode junctions of a multi-layered ceramic chip;
(B) keeping respective inner bonding surfaces of said two lead frames to face toward said electrode junctions of said multi-layered ceramic chip;
(C) filling a conductive polymer adhesive in between said electrode junctions of said multi-layered ceramic chip and said inner bonding surfaces of said two lead frames;
(D) enabling said inner bonding surfaces of said two lead frames to be respectively bonded to said electrode junctions of said multi-layered ceramic chip by said conductive polymer adhesive at a predetermined low bonding temperature to respectively electrically conduct said lead frames to said electrode junctions of said multi-layered ceramic chip;
(E) maintaining a predetermined buffer space between a respective bottom bonding portion of each said lead frame and a bottom side of said multi-layered ceramic chip; and
(F) forming the desired multi-layered ceramic electronic device.

2. The method for making a multi-layered ceramic electronic device as claimed in claim 1, wherein each said lead frame comprising said inner bonding surface and said bottom bonding portion perpendicularly extended from a bottom end of said inner bonding surface.

3. The method for making a multi-layered ceramic electronic device as claimed in claim 1, wherein said predetermined low bonding temperature is ≧200° C.

4. The method for making a multi-layered ceramic electronic device as claimed in claim 1, wherein said predetermined buffer space is in the range about 0.8 mm˜2.5 mm.

5. A multi-layered ceramic electronic device, comprising:
a multi-layered ceramic chip comprising two electrode junctions located at two opposite sides thereof;
two lead frames respectively attached to said electrode junctions of said multi-layered ceramic chip, each said lead frame comprising a flat inner bonding surface bonded to one respective said electrode junction of said multi-layered ceramic chip and a bottom bonding portion spaced below a bottom side of said multi-layered ceramic chip;
a buffer space defined between the bottom bonding portions of said lead frames and the bottom side of said multi-layered ceramic chip; and
a conductive polymer adhesive bonded between said two electrode junctions of said multi-layered ceramic chip and the inner bonding surfaces of said two lead frames to electrically conduct said lead frames to said multi-layered ceramic chip.

6. The multi-layered ceramic electronic device as claimed in claim 5, wherein the flat inner bonding surfaces of said lead frames are respectively bonded to the electrode junctions of said multi-layered ceramic chip conductive polymer adhesive by said conductive polymer adhesive at a low bonding temperature of ≧200° C.

7. The multi-layered ceramic electronic device as claimed in claim 5, wherein the flat inner bonding surfaces of said lead frames are respectively and most preferably bonded to the electrode junctions of said multi-layered ceramic chip conductive polymer adhesive by said conductive polymer adhesive at a low bonding temperature of ≧150° C.

8. The multi-layered ceramic electronic device as claimed in claim 5, wherein said lead frames have a L-shaped configuration with the respective bottom bonding portions thereof respectively perpendicularly extended from respective bottom ends of the respective inner bonding surfaces thereof.

9. The multi-layered ceramic electronic device as claimed in claim 5, wherein said conductive polymer adhesive contains 75%˜85% of metal and 15%˜25% of adhesive.

10. The multi-layered ceramic electronic device as claimed in claim 8, wherein the metal content of said conductive polymer adhesive is selected from the group of silver (Ag), copper (Cu) and nickel (Ni); the adhesive content of said conductive polymer adhesive is a polymer resin.
